(19) United States
(12) Patent Application Publication
(10) Pub. No.: US 2024/0062109 A1
(43) Pub. Date: Feb. 22, 2024

(54) ROBUSTNESS EVALUATION DEVICE, ROBUSTNESS EVALUATION METHOD AND RECORDING MEDIUM

(71) Applicant: NEC Corporation, Tokyo (JP)

(72) Inventor: Kazuya KAKIZAKI, Tokyo (JP)

(73) Assignee: NEC Corporation, Tokyo (JP)

(21) Appl. No.: 18/383,501

(22) Filed: Oct. 25, 2023

Related U.S. Application Data
(63) Continuation of application No. 17/637,120, filed on Feb. 22, 2022.

(51) Int. Cl. G06N 20/00; G06F 17/10; G06F 18/22

(52) U.S. Cl. CPC G06N 20/00; G06F 17/10; G06F 18/22

(57) ABSTRACT

A robustness evaluation device includes a similarity calculation unit that calculates the similarity between a feature of an input to an authentication model and a feature of a template; a local Lipschitz constant estimation unit, that estimates a local Lipschitz constant of a function for calculating similarity between the feature of the input to the authentication model and the feature of the template, in a sphere centered on the input to the authentication model; and an evaluation value estimation unit that estimates the evaluation value of robustness of the authentication model based on the similarity, the determination threshold value for the similarity, and the local Lipschitz constant.

This application is a Continuation of U.S. application Ser. No. 17/637,120 filed on Feb. 22, 2022, which is a National Stage Entry of PCT/JP2019/033890 filed on Aug. 29, 2019, the contents of all of which are incorporated herein by reference, in their entirety.

### TECHNICAL FIELD

The present invention relates to a robustness evaluation device, a robustness evaluation method, and a recording medium.

### BACKGROUND ART

In machine learning such as deep learning, a problem, of which a malfunction not expected by a designer during training may be induced by an adversarial example (AX) that is an artificial sample elaborately crafted to deceive a trained model, is known.

Regarding such an adversarial example, Non-Patent Document 1 proposes a quantitative robustness evaluation method against an adversarial example targeting a classifier g:R^{d}→R^{k}. The classifier disclosed in Non-Patent Document 1 outputs classification degrees represented by k real numbers respectively corresponding to k classification target classes with respect to input data. In this classifier, learning is performed using deep learning so that the classification degree of the true class becomes the highest with respect to the input data.

### PRIOR ART DOCUMENTS

### Non-Patent Literature

[Non-Patent Document 1] Tsui-Wei Weng et al., “EVALUATING THE ROBUSTNESS OF NEURAL NETWORKS: AN EXTREME VALUE THEORY APPROACH”, International Conference on Learning Representations (ICLR), 2018

### SUMMARY OF THE INVENTION

### Problem to be Solved by the Invention

The method described in Non-Patent Document 1 is a method of calculating a robustness evaluation value for a classifier. Therefore, in the method described in Non-Patent Document 1, it is not possible to calculate the robustness of the authentication model using a feature extractor, a template of authentication target data, and a threshold value against the adversarial example.

An object of the present invention is to provide a robustness evaluation device, a robustness evaluation method, and a recording medium that can solve the above problem.

### Means for Solving the Problem

According to a first example aspect of the present invention, a robustness evaluation device includes: a similarity calculation unit that calculates the similarity between a feature of an input to an authentication model and a feature of a template; a local Lipschitz constant estimation unit, that estimates a local Lipschitz constant of a function for calculating similarity between the feature of the input to the authentication model and the feature of the template, in a sphere centered on the input to the authentication model; and an evaluation value estimation unit that estimates an evaluation value of robustness of the authentication model based on the similarity, a determination threshold value for the similarity, and the local Lipschitz constant.

According to a second example aspect of the present invention, a robustness evaluation method includes: calculating a similarity between a feature of an input to an authentication model and a feature of a template; estimating a local Lipschitz constant of a function for calculating similarity between the feature of the input to the authentication model and the feature of the template, in a sphere centered on the input to the authentication model; and estimating an evaluation value of robustness of the authentication model based on the similarity, a determination threshold value for the similarity, and the local Lipschitz constant.

According to a third example aspect of the present invention, a recording medium is a recording medium in which a program is recorded, the program causing a computer to execute: calculating a similarity between a feature of an input to an authentication model and a feature of a template; estimating a local Lipschitz constant of a function for calculating similarity between the feature of the input to the authentication model and the feature of the template, in a sphere centered on the input to the authentication model; and estimating an evaluation value of robustness of the authentication model based on the similarity, a determination threshold value for the similarity, and the local Lipschitz constant.

### Effect of the Invention

According to the above-described robustness evaluation device, the robustness evaluation method, and the recording medium, the robustness of the authentication model can be calculated.

### BRIEF DESCRIPTION OF THE DRAWINGS

FIG. 1 is a schematic block diagram illustrating a configuration example of a robustness evaluation device according to a first example embodiment.

FIG. 2 is a diagram illustrating an example of an authentication model to be a target of calculation of a robustness evaluation value by the robustness evaluation device according to the first example embodiment.

FIG. 3 is a flowchart illustrating an example of a processing procedure in which the robustness evaluation device according to the first example embodiment calculates the robustness evaluation value of the authentication model.

FIG. 4 is a schematic block diagram illustrating a configuration example of a robustness evaluation device according to a second example embodiment.

FIG. 5 is a diagram illustrating an example of an authentication model to be a target of calculation of a robustness evaluation value by the robustness evaluation device according to the second example embodiment.

FIG. 6 is a flowchart illustrating an example of a processing procedure in which the robustness evaluation device calculates the robustness evaluation value of the authentication model.

FIG. 7 is a schematic block diagram illustrating a configuration example of a robustness evaluation device according to a third example embodiment.

FIG. 8 is a flowchart illustrating an example of a processing procedure in which the robustness evaluation device according to the third example embodiment calculates a robustness evaluation value of an authentication model.

FIG. 9 is a schematic block diagram illustrating a configuration example of a robustness evaluation device according to a fourth example embodiment.

FIG. 10 is a flowchart illustrating an example of a processing procedure in which the robustness evaluation device according to the fourth example embodiment calculates a robustness evaluation value of an authentication model.

FIG. 11 is a schematic block diagram illustrating a configuration example of a local Lipschitz constant estimation device according to a fifth example embodiment.

FIG. 12 is a flowchart illustrating an example of a processing procedure in which the local Lipschitz constant estimation device according to the fifth example embodiment estimates a local Lipschitz constant.

FIG. 13 is a diagram illustrating a configuration example of a robustness evaluation device according to a sixth example embodiment.

FIG. 14 is a flowchart illustrating an example of a procedure of processing in a robustness evaluation method according to a seventh example embodiment.

FIG. 15 is a schematic block diagram illustrating a configuration of a computer according to at least one example embodiment.

### EXAMPLE EMBODIMENT

Hereinafter, example embodiments of the present invention will be described, but the following example embodiments do not limit the invention according to the claims. In addition, not all combinations of features described in the example embodiments are essential to the solution of the invention.

### First Example Embodiment

FIG. 1 is a schematic block diagram illustrating a configuration example of a robustness evaluation device according to a first example embodiment. In the configuration illustrated in FIG. 1, a robustness evaluation device 100 includes an evaluation value estimation unit 102, a difference calculation unit 104, and a local Lipschitz constant estimation unit 106. The difference calculation unit 104 includes a similarity calculation unit 105.

The robustness evaluation device 100 calculates a quantitative evaluation value of the robustness of the authentication model against an adversarial example generated for the purpose of “dodging” the authentication model.

The authentication dodging means that the authentication model fails in authentication although data of the authentication target same as the authentication target authenticated using the registered template is input. For example, in the case of an authentication model that performs face authentication, the face of the authentication target person is the authentication target. In the authentication dodging, the authentication model fails in the face authentication although the face image of the person same as the authentication target person whose face image is registered as the template is input.

It is important to quantitatively evaluate the robustness of the authentication model against adversarial examples. When the authentication model is “robust”, it is difficult for the authentication result by the authentication model to be different when certain data is input to the authentication model and when an adversarial example obtained by processing the data is input to the authentication model. Processing data is expressed as adding noise to the data. When data before processing is x and noise is δ, data after processing is represented by x+δ.

When the robustness of the authentication model can be quantitatively evaluated, the authentication model can be compared from the viewpoint of robustness. The evaluation value of the robustness of the authentication model can be used as a reference for constructing a more robust authentication model against the adversarial example. Furthermore, the evaluation value of the robustness of the authentication model can be used as a reference for constructing a system including a more robust authentication model against the adversarial example.

The robustness evaluation device 100 sets an authentication model using an index indicating that the smaller the value, the higher the similarity, as an index of the similarity between the features, as a target for calculating the robustness evaluation value. When the similarity is calculated using such an index, the authentication model determines the authentication result as an authentication success if an index value of the similarity between the features is equal to or less than a threshold value, and as an authentication failure if the index value is larger than the threshold value. Examples of such an index include Euclidean distance.

In the first example embodiment, a case where an authentication model using a Euclidean distance as an index of similarity is a target of calculation of a robustness evaluation value will be described as an example. However, the similarity index used by the authentication model in the first example embodiment is not limited to the Euclidean distance, and various indices indicating that the smaller the value, the higher the similarity may be used.

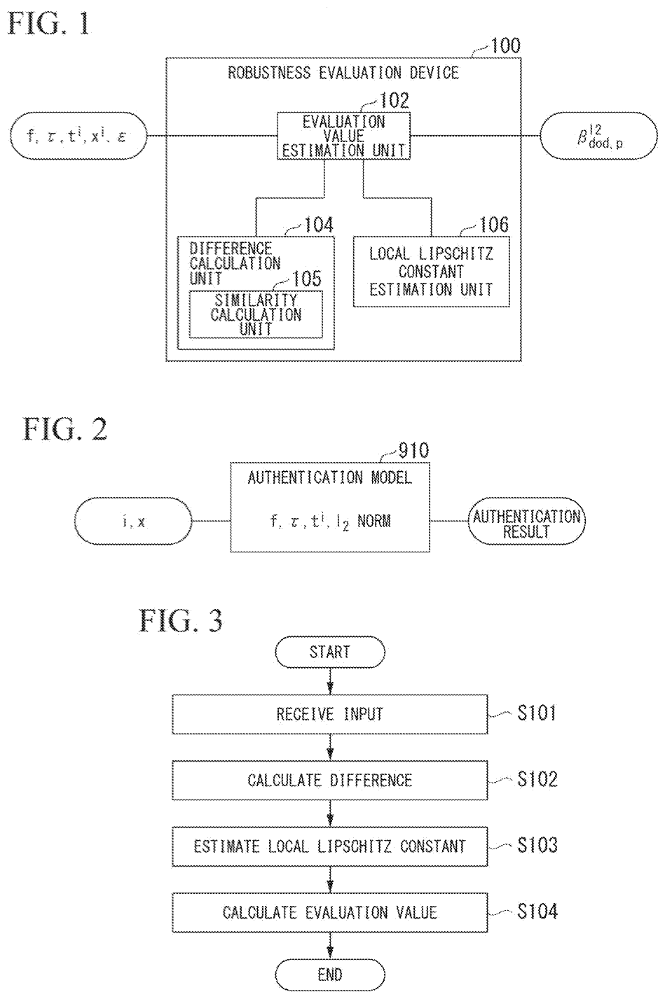

FIG. 2 is a diagram illustrating an example of an authentication model to be a target of calculation of a robustness evaluation value by the robustness evaluation device 100. An authentication model to be a target of calculation of a robustness evaluation value by the robustness evaluation device 100 is referred to as an authentication model 910.

A feature extractor of the authentication model 910 is indicated by f, a threshold value is indicated by τ, and a template of the authentication target i is indicated by tⁱ. In addition, the authentication model 910 uses a Euclidean distance as an index of the similarity of the features.

The threshold value τ corresponds to an example of a determination threshold value for determining whether the authentication is successful, which is applied to the similarity of the features.

i is a positive integer indicating an identification number for identifying the authentication target. When a plurality of templates are registered in the authentication model 910, any one of the plurality of templates is designated, and the authentication model 910 performs authentication using the designated template. The authentication model 910 performs authentication by determining whether the authentication target indicated in the input data is the same authentication target as the authentication target in which the template is registered based on the similarity between the feature of the input data and the feature of the specified template.

The feature extractor f is expressed as f:R^{d}→R^{m}. Here, R represents a real number. d and m each represent a positive integer. The feature extractor f receives data of a d-dimensional real vector and outputs a feature indicated by an m-dimensional real vector.

The threshold value τ is a real number of τ>0.

The template tⁱ of the authentication target i is data of the d-dimensional real vector. Thus, it is denoted that tⁱ ∈R^{d}.

The feature extractor f outputs a vector (feature vector) indicating a similar feature with respect to the data of the same authentication target. For example, in a case where the authentication model 910 performs face authentication, the feature extractor f outputs a feature vector having high similarity to different face images of the same person.

The form of the feature extractor f is not limited to a specific form. For example, the feature extractor f may be generated by performing deep learning by a deep neural network (DNN), but the present invention is not limited thereto.

When one template tⁱ is designated and data x∈R^{d} is input, the authentication model 910 calculates an index value indicating similarity between the feature of the input data x and the feature of the designated template tⁱ. Then, the authentication model 910 compares the calculated index value with the threshold value τ. In a case where it is determined that the index value is equal to or less than the threshold value τ, the authentication model 910 outputs an authentication result of authentication success. In a case where it is determined that the index value is larger than the threshold value τ, the authentication model 910 outputs an authentication result of authentication failure.

The robustness evaluation device 100 assumes that the adversarial example xⁱ+δ, obtained by adding the noise δ∈R^{d} to the data xⁱ∈R^{d} of the authentication target i, is input to the authentication model 910, and calculates the robustness evaluation value of the authentication model at that time. The robustness evaluation device 100 estimates the lower limit β_{dod,p}¹² of the minimum perturbation size Δp,min¹² necessary for achieving the authentication dodging, as the robustness evaluation value.

The minimum perturbation size Δ_{p,min}¹² is expressed by Expression (1).

$$\begin{matrix}[ Math . 1 ] & \\ {Δ}_{p , min}^{12} = {min}_{δ ∈ {R}^{d}} {‖ δ ‖}_{p} s . t . {‖ f ( {x}^{i} + δ ) - f ( {t}^{i} ) ‖}_{2} > τ & ( 1 )\end{matrix}$$

“∥ ∥ₚ” indicates lₚ norm. “∥δ∥”ₚ indicates lₚ norm of the noise δ∈R^{d}. p may be any of 1, 2, and ∞.

“f(xⁱ+δ)” indicates the feature of the adversarial example xⁱ+δ in which the noise δ is added to the data xⁱ. “f(tⁱ)” indicates the feature of the template tⁱ.

“∥f(xⁱ+δ)−f(tⁱ)∥₂” indicates an index value by the l₂ norm of the similarity between the feature of the adversarial example xⁱ+δ and the feature of the template tⁱ. l₂ norm is also referred to as a Euclidean distance.

“∥f(xⁱ+δ)−f(tⁱ)∥₂>τ” indicates a determination criterion for the authentication model 910 to determine that the authentication fails. Therefore, the minimum perturbation size Δ_{p,min}¹² indicates the minimum lₚ norm in which the authentication dodging occurs among the lₚ norm of the noise δ.

If the lₚ norm “∥δ∥ₚ” of the noise δ is smaller than the minimum perturbation size Δ_{p,min}¹², the authentication model 910 determines that authentication succeeds with authentication based on the adversarial example xⁱ+δ and the template tⁱ. That is, when the lₚ norm “∥δ∥ₚ” of the noise δ is smaller than the minimum perturbation size Δ_{p,min}¹², the authentication dodging does not occur.

In general, it is difficult to calculate the minimum perturbation size Δ_{p,min}¹². Therefore, the robustness evaluation device 100 estimates the lower limit β_{dod,p}¹² of the minimum perturbation size Δ_{p,min}¹² as the robustness evaluation value. Since β_{dod,p}¹² is the lower limit of the minimum perturbation size Δ_{p,min}¹², it is expressed by Expression (2).

[Math. 2]

β_{dod,p}¹²≤Δ_{p,min}¹² (2)

p may be any of 1, 2, and ∞. If the lₚ norm “∥δ∥ₚ” of the noise δ is smaller than the lower limit β_{dod,p}¹² of the minimum perturbation size, the authentication dodging does not occur.

When the feature extractor f, the threshold value τ, the template tⁱ ∈R^{d} of the authentication target i, the input data xⁱ∈R^{d} of the authentication target i, and the parameter ε>0 are input, the robustness evaluation device 100 estimates the lower limit β_{dod,p}¹² of the minimum perturbation size Δ_{p,min}¹² and outputs the estimated lower limit as the robustness evaluation value.

The robustness evaluation device 100 calculates the lower limit β_{dod,p}¹² of the minimum perturbation size with respect to the input data xⁱ∈R^{d} of the authentication model 910 using Expression (3).

$$\begin{matrix}[ Math . 3 ] & \\ {β}_{dod , p}^{12} = min \{ \frac{τ - {‖ f ( {x}^{i} ) - f ( {t}^{i} ) ‖}_{2}}{{L}_{{x}^{i} , ε}^{12}} , ε \} & ( 3 )\end{matrix}$$

“τ−∥f(xⁱ)−f(tⁱ)∥₂” represents a difference obtained by subtracting the similarity between the feature f(xⁱ) calculated from the input data xⁱ and the feature f(tⁱ) calculated from the template tⁱ from the threshold value τ.

“L_{xi,ε}¹²” indicates a local Lipschitz constant in a sphere Bₚⁱ of a function h¹²(x) expressed by Expression (4).

[Math. 4]

h¹²(x)=∥f(x)−f(tⁱ)∥₂ (4)

The sphere Bₚⁱ is a sphere expressed by Expression (5).

[Math. 5]

Bₚⁱ={x∈R^{d}|∥x−xⁱ∥ₚ≤ε} (5)

The center of the sphere Bₚⁱ is xⁱ, and the radius of the sphere Bₚⁱ is ε. ε represents a parameter used when the local Lipschitz constant is obtained, and ε>0. For example, the user of the robustness evaluation device 100 may determine the value of the parameter ε and input the determined value to the robustness evaluation device 100. Alternatively, the robustness evaluation device 100 may store a predetermined value of the parameter ε.

Here, the local Lipschitz constant will be described.

S⊂R^{d} is an area closed by a convex boundary, and the function h(x) is h(x):S→R. That is, the function h(x) is a continuous function for the region S that projects a d-dimensional real vector in the region S to a real number. In a case where Expression (6) is true when x and y are respectively arbitrary d-dimensional real vectors included in the region S, the function h(x) is referred to as a Lipschitz function of the Lipschitz constant L_{q}.

[Math. 6]

|h(x)−h(y)|≤L_{q}∥x−y∥ₚ (6)

In particular, the Lipschitz constant at and around a particular x₀∈R^{d} is referred to as a local Lipschitz constant.

In the first example embodiment, as described above, the local Lipschitz constant L_{xi,ε}¹² of the function h¹² in the sphere Bₚⁱ centered on xⁱ is used.

Note that the Lipschitz constant and the local Lipschitz constant are described in, for example, Non-Patent Document 1.

As a method by which the robustness evaluation device 100 calculates the local Lipschitz constant L_{xi,ε}¹², a known method can be used. For example, the robustness evaluation device 100 may calculate the local Lipschitz constant L_{xi,ε}¹² based on Expression (7).

[Math. 7]

Lₓ_{ⁱ}_{,ε}¹²=max{∥∇h¹²(x)∥_{q}:x∈Bₚⁱ} (7)

∇ indicates a nabla operator, and ∇h(x) is expressed by Expression (8).

$$\begin{matrix}[ Math . 8 ] & \\ ∇ h ( x ) = ( \frac{\partial h ( x )}{\partial {x}_{1}} , … , \frac{\partial h ( x )}{\partial {x}_{d}} ) & ( 8 )\end{matrix}$$

q is a positive integer satisfying Expression (9).

$$\begin{matrix}[ Math . 9 ] & \\ \frac{1}{p} + \frac{1}{q} = 1 , 1 ≦ p , q ≦ ∞ & ( 9 )\end{matrix}$$

As described above, p takes any value of 1, 2, and ∞. When p=1, q=∞. When p=2, q=2. When p=∞, q=1.

The difference calculation unit 104 calculates a difference “τ−∥f(xⁱ)−f(tⁱ)∥₂” obtained by subtracting the similarity between the feature f(xⁱ) calculated from the input data xⁱ and the feature f(tⁱ) calculated from the template tⁱ from the threshold value τ.

The similarity calculation unit 105 of the difference calculation unit 104 calculates the similarity “∥f(xⁱ)−f(tⁱ)∥₂” between the feature f(xⁱ) calculated from the input data xⁱ and the feature f(tⁱ) calculated from the template tⁱ.

The local Lipschitz constant estimation unit 106 calculates the local Lipschitz constant L_{xi,ε}¹² described above.

The evaluation value estimation unit 102 calculates “(τ−∥f(xⁱ)−f(tⁱ)∥₂)/L_{xi,ε}¹²” using the value of “τ−∥f(xⁱ)−f(tⁱ)∥₂” calculated by the difference calculation unit 104 and the local Lipschitz constant L_{xi,ε}¹² calculated by the local Lipschitz constant estimation unit 106. The evaluation value estimation unit 102 compares the value of “(τ−∥f(xⁱ)−f(tⁱ)∥₂)/L_{xi,ε}¹²” with the value of the parameter ε, and outputs the smaller value as the lower limit β_{dod,p}¹² of the minimum perturbation size Δ_{p,min}¹².

The operation of the robustness evaluation device 100 will be described with reference to FIG. 3.

FIG. 3 is a flowchart illustrating an example of a processing procedure in which the robustness evaluation device 100 calculates the robustness evaluation value of the authentication model.

In the processing of FIG. 3, the evaluation value estimation unit 102 receives inputs of the feature extractor f:R^{d}→R^{m}, the threshold value τ>0, the template tⁱ ∈R^{d} of the authentication target i, the input data xⁱ∈R^{d} of the authentication target i, and the parameter ε>0 (step S101).

Next, the difference calculation unit 104 calculates a difference “τ−∥f(xⁱ)−f(tⁱ)∥₂” obtained by subtracting the similarity between the feature f(xⁱ) calculated from the input data xⁱ and the feature f(tⁱ) calculated from the template tⁱ from the threshold value τ (step S102). In step S102, the similarity calculation unit 105 calculates the similarity “∥f(xⁱ)−f(tⁱ)∥₂” between the feature f(xⁱ) calculated from the input data xⁱ and the feature f(tⁱ) calculated from the template tⁱ.

Next, the local Lipschitz constant estimation unit 106 estimates the local Lipschitz constant L_{xi,ε}¹² of the function h¹²(x)=∥f(x)−f(tⁱ)∥₂ in the sphere Bₚⁱ expressed by the above Expression (5) (step S103).

Next, the evaluation value estimation unit 102 calculates and outputs the lower limit β_{dod,p}¹² of the minimum perturbation size Δ_{p,min}¹² (step S104). Specifically, the evaluation value estimation unit 102 calculates “(τ−∥f(xⁱ)−f(tⁱ)∥₂)/L_{xi,ε}¹²” using the value of “τ−∥f(xⁱ)−f(tⁱ)∥₂” calculated by the difference calculation unit 104 and the local Lipschitz constant L_{xi,ε}¹² estimated by the local Lipschitz constant estimation unit 106. The evaluation value estimation unit 102 calculates the smaller value of the value of “(τ−∥f(xⁱ)−f(tⁱ)∥₂)/L_{xi,ε}¹²” and the value of the parameter ε as the lower limit β_{dod,p}¹² of the minimum perturbation size Δ_{p,min}¹², and outputs the calculated value.

After step S104, the robustness evaluation device 100 ends the process of FIG. 3.

As described above, the similarity calculation unit 105 calculates the similarity between the feature of the input to the authentication model and the feature of the template. The local Lipschitz constant estimation unit 106 estimates a local Lipschitz constant of a function for calculating the similarity between the feature of the input to the authentication model and the feature of the template in the sphere centered on the input to the authentication model. The evaluation value estimation unit 102 estimates the evaluation value of the robustness of the authentication model based on the similarity calculated by the similarity calculation unit 105, the determination threshold value for the similarity, and the local Lipschitz constant.

As a result, according to the robustness evaluation device 100, the robustness of the authentication model can be quantitatively evaluated.

Here, the classifier that classifies the input data and the authentication model are different from each other in both the problem to be solved by each of the classifier and the authentication model and the method for determining the output. The classifier classifies the input data into a class having the largest classification degree. On the other hand, the authentication model performs authentication by comparing the similarity between the feature of the input data calculated using the feature extractor and the feature of the template and the threshold value. Therefore, a calculation formula of the robustness evaluation value of the classifier cannot be used to calculate the robustness evaluation value for the adversarial example of the authentication model. On the other hand, according to the robustness evaluation device 100, the robustness of the authentication model can be quantitatively evaluated.

In addition, the similarity calculation unit 105 calculates the similarity based on the Euclidean distance. The evaluation value estimation unit 102 estimates an evaluation value of the robustness of the authentication model against authentication dodging, based on a value obtained by subtracting the similarity calculated by the similarity calculation unit 105 from a determination threshold value and subtracting the local Lipschitz constant.

As a result, according to the robustness evaluation device 100, it is possible to quantitatively evaluate the robustness of the authentication model against the adversarial example generated for the purpose of authentication dodging.

### Second Example Embodiment

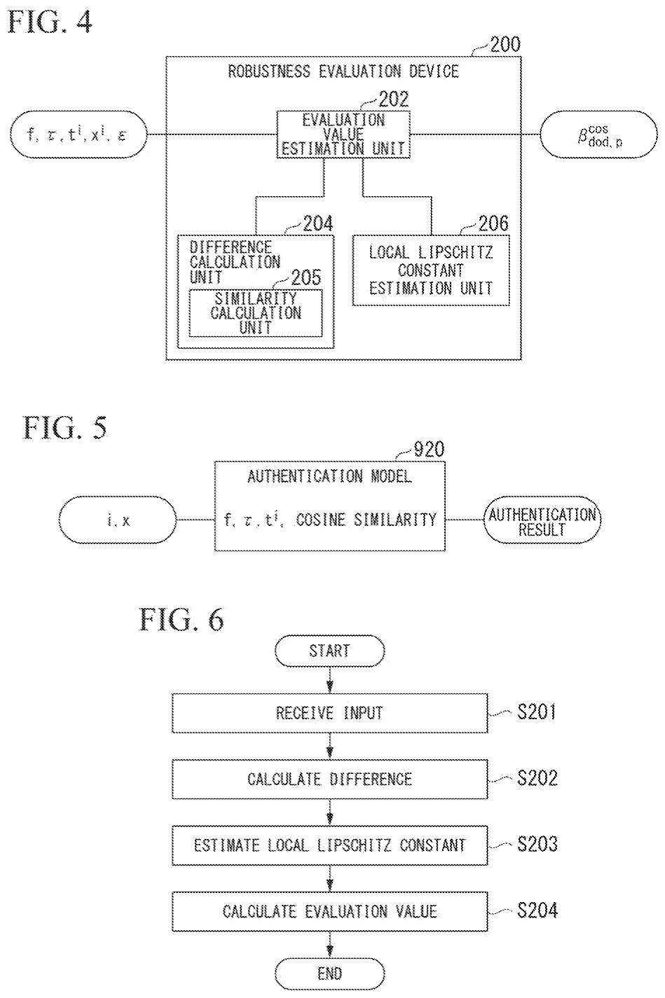

FIG. 4 is a schematic block diagram illustrating a configuration example of a robustness evaluation device according to a second example embodiment. In the configuration illustrated in FIG. 4, a robustness evaluation device 200 includes an evaluation value estimation unit 202, a difference calculation unit 204, and a local Lipschitz constant estimation unit 206. The difference calculation unit 204 includes a similarity calculation unit 205.

As in the case of robustness evaluation device 100 (see FIG. 1), the robustness evaluation device 200 calculates a quantitative evaluation value of the robustness of the authentication model against an adversarial example generated for the purpose of “dodging” the authentication model.

On the other hand, the robustness evaluation device 200 sets an authentication model using an index indicating that the larger the value, the higher the similarity, as an index of the similarity between the features, as a target for calculating the robustness evaluation value. In this respect, the robustness evaluation device 200 is different from the robustness evaluation device 100.

When the similarity is calculated using such an index, the authentication model determines the authentication result as an authentication success if an index value of the similarity between the features is equal to or larger than a threshold value, and as an authentication failure if the index value is less than the threshold value. Examples of such an index include cosine similarity.

In the second example embodiment, a case where an authentication model using cosine similarity as an index of similarity is a target of calculation of a robustness evaluation value will be described as an example. However, the similarity index used by the authentication model in the second example embodiment is not limited to the cosine similarity, and various indices indicating that the larger the value, the higher the similarity may be used.

FIG. 5 is a diagram illustrating an example of an authentication model to be a target of calculation of a robustness evaluation value by the robustness evaluation device 200. An authentication model to be a target of calculation of a robustness evaluation value by the robustness evaluation device 200 is referred to as an authentication model 920. The feature extractor f, the threshold value τ, and the template tⁱ of the authentication target i of the authentication model 920 are similar to those of the authentication model 910 (see FIG. 2). A specific value of the threshold value τ may be different from that of the authentication model 910.

The authentication model 920 is different from the authentication model 910 in that cosine similarity is used as an index of similarity of features. Otherwise, the authentication model 920 is similar to the authentication model 910.

As in the case of the first example embodiment, “i” of the template tⁱ is a positive integer indicating an identification number for identifying the authentication target. When a plurality of templates are registered in the authentication model 920, any one of the plurality of templates is designated, and the authentication model 920 performs authentication using the designated template. The authentication model 920 performs authentication by determining whether the authentication target indicated in the input data is the same authentication target as the authentication target in which the template is registered based on the similarity between the feature of the input data and the feature of the specified template.

When one template tⁱ is designated and data x∈R^{d} is input, the authentication model 920 calculates an index value indicating similarity between the feature of the input data x and the feature of the designated template tⁱ. Then, the authentication model 920 compares the calculated index value with the threshold value T. In a case where it is determined that the index value is equal to or larger than the threshold value τ, the authentication model 910 outputs an authentication result of authentication success. In a case where it is determined that the index value is less than the threshold value τ, the authentication model 920 outputs an authentication result of authentication failure.

The robustness evaluation device 200 assumes that the adversarial example xⁱ+δ, obtained by adding the noise δ∈R^{d} to the data xⁱ∈R^{d} of the authentication target i, is input to the authentication model 920, and calculates the robustness evaluation value of the authentication model at that time. The robustness evaluation device 200 estimates the lower limit β_{dod,p}^{cos} of the minimum perturbation size Δ_{p,min}^{cos} necessary for achieving the authentication dodging, as the robustness evaluation value.

The minimum perturbation size Δ_{p,min}^{cos} is expressed by Expression (10).

$$\begin{matrix}[ Math . 10 ] & \\ {Δ}_{p , min}^{cos} = {min}_{δ ∈ {R}^{d}} {‖ δ ‖}_{p} s . t . cos ( f ( {x}^{i} + δ ) , f ( {t}^{i} ) ) < τ & ( 10 )\end{matrix}$$

“cos(,)” is a function for calculating cosine similarity between two vectors. “cos(f(xⁱ+δ),f(tⁱ))” indicates cosine similarity between the feature “f(xⁱ+δ)” of the adversarial example xⁱ+δ and the feature “f(tⁱ)” of the template tⁱ.

“cos(f(xⁱ+δ),f(tⁱ))<τ” indicates a determination criterion for the authentication model 920 to determine that the authentication fails. Therefore, the minimum perturbation size Δ_{p,min}^{cos} indicates the minimum lₚ norm in which the authentication dodging occurs among the lₚ norm of the noise δ.

If the lₚ norm “∥δ∥ₚ” of the noise δ is smaller than the minimum perturbation size Δ_{p,min}^{cos}, the authentication model 920 determines that authentication succeeds with authentication based on the adversarial example xⁱ+δ and the template tⁱ. That is, when the lₚ norm “∥δ∥ₚ” of the noise δ is smaller than the minimum perturbation size Δ_{p,min}^{cos}, the authentication dodging does not occur.

In general, it is difficult to calculate the minimum perturbation size Δ_{p,min}^{cos}. Therefore, the robustness evaluation device 200 estimates the lower limit β_{dod,p}^{cos} of the minimum perturbation size Δ_{p,min}^{cos} as the robustness evaluation value. Since β_{dod,p}^{cos} is the lower limit of the minimum perturbation size Δ_{p,min}^{cos}, it is expressed by Expression (11).

[Math. 11]

β_{dod,p}^{cos}≤Δ_{p,min}^{cos} (11)

p may be any of 1, 2, and ∞. If the lₚ norm “∥δ∥ₚ” of the noise δ is smaller than the lower limit β_{dod,p}^{cos} of the minimum perturbation size, the authentication dodging does not occur.

When the feature extractor f, the threshold value τ, the template tⁱ∈R^{d} of the authentication target i, the input data xⁱ∈R^{d} of the authentication target i, and the parameter ε>0 are input, the robustness evaluation device 200 estimates the lower limit β_{dod,p}^{cos} of the minimum perturbation size and outputs the estimated lower limit as the robustness evaluation value.

The robustness evaluation device 200 calculates the lower limit β_{dod,p}^{cos} of the minimum perturbation size with respect to the input data xⁱ∈R^{d} of the authentication model 920 using Expression (12).

$$\begin{matrix}[ Math . 12 ] & \\ {β}_{dod , p}^{cos} = min \{ \frac{cos ( f ( {x}^{i} ) , f ( {t}^{i} ) ) - τ}{{L}_{{x}^{i} , ε}^{cos}} , ε \} & ( 12 )\end{matrix}$$

“cos(f(xⁱ),f(tⁱ))−τ” represents a difference obtained by subtracting the threshold value τ from the similarity between the feature f(xⁱ) calculated from the input data xⁱ and the feature f(tⁱ) calculated from the template tⁱ.

“L_{xi,ε}^{cos}” indicates the local Lipschitz constant of the function h^{cos}(x) indicated by Expression (13) in the sphere Bₚⁱ indicated by Expression (5).

[Math. 13]

h^{cos}(x)=cos(f(x),f(tⁱ)) (13)

As a method by which the robustness evaluation device 200 calculates the local Lipschitz constant L_{xi,ε}^{cos}, a known method can be used. For example, the robustness evaluation device 200 may calculate the local Lipschitz constant L_{xi,ε}^{cos} based on Expression (14).

[Math. 14]

Lₓ_{ⁱ}_{,ε}^{cos}=max{∥∇h^{cos}(x)∥_{q}:x∈Bₚⁱ} (14)

Expression (14) is different from Expression (7) in that L_{xi,ε}^{cos} is on the left side of the Formula and the function h^{cos}(x) is shown on the right side of the Formula. Other than that, Expression (14) is same as Expression (7).

The difference calculation unit 204 calculates a difference “cos(f(xⁱ),f(tⁱ))−τ” obtained by subtracting the threshold value τ from the similarity between the feature f(xⁱ) calculated from the input data xⁱ and the feature f(tⁱ) calculated from the template tⁱ.

The similarity calculation unit 205 of the difference calculation unit 204 calculates the similarity “cos(f(xⁱ),f(tⁱ))” between the feature f(xⁱ) calculated from the input data xⁱ and the feature f(tⁱ) calculated from the template tⁱ.

The local Lipschitz constant estimation unit 206 calculates the local Lipschitz constant L_{xi,ε}^{cos} described above.

The evaluation value estimation unit 202 calculates “(cos(f(xⁱ),f(tⁱ))−τ)/L_{xi,ε}^{cos}” using the value of “cos(f(xⁱ),f(tⁱ))−τ” calculated by the difference calculation unit 204 and the local Lipschitz constant L_{xi,ε}^{cos} calculated by the local Lipschitz constant estimation unit 206. The evaluation value estimation unit 202 compares the value of “(cos(f(xⁱ),f(tⁱ))−τ)/L_{xi,ε}^{cos}” with the value of the parameter ε, and outputs the smaller value as the lower limit β_{dod,p}^{cos} of the minimum perturbation size Δ_{p,min}^{cos}.

The operation of the robustness evaluation device 200 will be described with reference to FIG. 6.

FIG. 6 is a flowchart illustrating an example of a processing procedure in which the robustness evaluation device 200 calculates the robustness evaluation value of the authentication model.

In the processing of FIG. 6, the evaluation value estimation unit 202 receives inputs of the feature extractor f:R^{d}→R^{m}, the threshold value τ>0, the template tⁱ ∈R^{d} of the authentication target i, the input data xⁱ∈R^{d} of the authentication target i, and the parameter ε>0 (step S201).

Next, the difference calculation unit 204 calculates a difference “cos(f(xⁱ),f(tⁱ))−τ” obtained by subtracting the threshold value τ from the similarity between the feature f(xⁱ) calculated from the input data xl and the feature f(tⁱ) calculated from the template tⁱ (step S202). In step S202, the similarity calculation unit 205 calculates the similarity “cos(f(xⁱ),f(tⁱ))” between the feature f(xⁱ) calculated from the input data xⁱ and the feature f(tⁱ) calculated from the template tⁱ.

Next, the local Lipschitz constant estimation unit 206 estimates the local Lipschitz constant L_{xi,ε}^{cos} of the function h^{cos}(x)=cos(f(x),f(tⁱ)) in the sphere Bₚⁱ expressed by the above Expression (5) (step S203).

Next, the evaluation value estimation unit 202 calculates and outputs the lower limit β_{dod,p}^{cos} of the minimum perturbation size Δ_{p,min}^{cos} (step S204). Specifically, the evaluation value estimation unit 202 calculates “(cos(f(xⁱ),f(tⁱ))−τ)/L_{xiε}^{cos}” using the value of “cos(f(xⁱ),f(tⁱ))−τ” calculated by the difference calculation unit 204 and the local Lipschitz constant L_{xi,ε}^{cos} estimated by the local Lipschitz constant estimation unit 206. The evaluation value estimation unit 202 calculates the smaller value of the value of “(cos(f(xⁱ),f(tⁱ))−τ)/L_{xi,ε}^{cos}” and the value of the parameter ε as the lower limit β_{dod,p}^{cos} of the minimum perturbation size Δ_{p,min}^{cos}, and outputs the calculated value.

After step S204, the robustness evaluation device 200 ends the process of FIG. 6.

As described above, the similarity calculation unit 205 calculates cosine similarity. The evaluation value estimation unit 202 estimates an evaluation value of the robustness of the authentication model against authentication dodging, based on a value obtained by subtracting a determination threshold value from the similarity calculated by the similarity calculation unit 205 and subtracting the local Lipschitz constant.

As a result, according to the robustness evaluation device 200, it is possible to quantitatively evaluate the robustness of the authentication model against the adversarial example generated for the purpose of authentication dodging.

### Third Example Embodiment

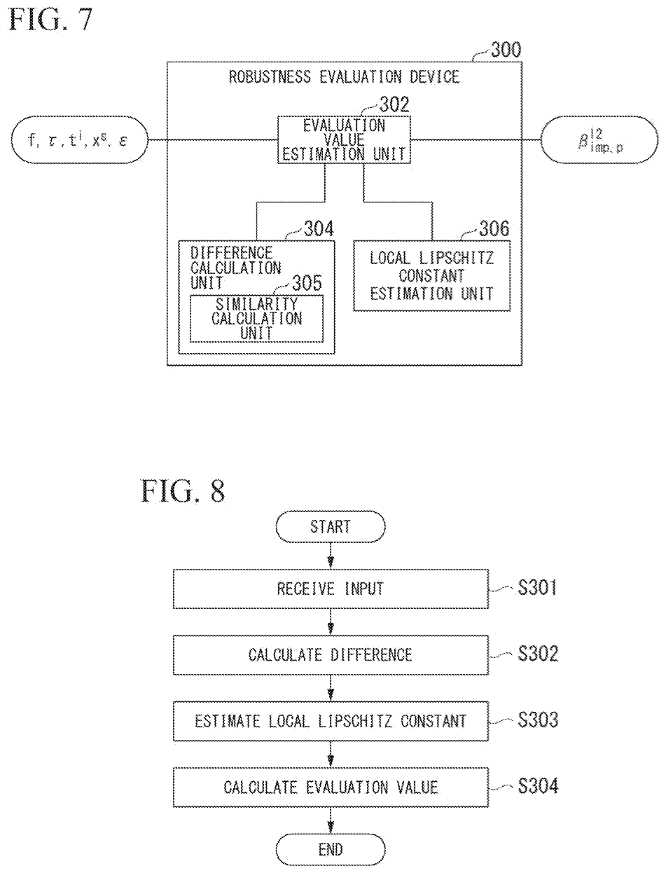

FIG. 7 is a schematic block diagram illustrating a configuration example of a robustness evaluation device according to a third example embodiment. In the configuration illustrated in FIG. 7, a robustness evaluation device 300 includes an evaluation value estimation unit 302, a difference calculation unit 304, and a local Lipschitz constant estimation unit 306. The difference calculation unit 304 includes a similarity calculation unit 305.

The robustness evaluation device 300 calculates a quantitative evaluation value of the robustness of the authentication model against an adversarial example generated for the purpose of “impersonation” in the authentication model.

Impersonation means that an authentication model succeeds in authentication although data of an authentication target different from an authentication target authenticated using a registered template is input. For example, in a case of an authentication model that performs face authentication, in impersonation, the authentication model succeeds in the face authentication although a face image of a person different from an authentication target person whose face image is registered as a template is input.

As in the case of the robustness evaluation device 100, the robustness evaluation device 300 sets an authentication model using an index indicating that the smaller the value, the higher the similarity, as an index of the similarity between the features, as a target for calculating the robustness evaluation value. As described above, when the similarity is calculated using such an index, the authentication model determines the authentication result as an authentication success if an index value of the similarity between the features is equal to or less than a threshold value, and as an authentication failure if the index value is larger than the threshold value. Examples of such an index include Euclidean distance.

In the third example embodiment, a case where an authentication model using a Euclidean distance as an index of similarity is a target of calculation of a robustness evaluation value will be described as an example. However, the similarity index used by the authentication model in the third example embodiment is not limited to the Euclidean distance, and various indices indicating that the smaller the value, the higher the similarity may be used.

As in the case of the robustness evaluation device 100, the robustness evaluation device 300 calculates the robustness evaluation value using the authentication model 910 (see FIG. 2).

The robustness evaluation device 300 assumes that the adversarial example x^{s}+δ, obtained by adding the noise δ∈R^{d} to the data x^{s}∈R^{d} of the authentication target s, is input to the authentication model 910, and calculates the robustness evaluation value of the authentication model at that time.

Here, s≠i. Specifically, a case where an adversarial example is generated using data of a person different from the authentication target person whose template is registered is considered.

The robustness evaluation device 300 estimates the lower limit β_{imp,p}¹² of the minimum perturbation size Δ_{p,imp}¹² necessary for achieving the impersonation, as the robustness evaluation value.

The minimum perturbation size Δ_{p,imp}¹² is expressed by Expression (15).

[Math. 15]

Δ_{p,imp}¹²=min∥δ∥ₚs.t.∥f(x^{s}+δ)−f(tⁱ)∥₂≤τ (16)

“f(x^{s}+δ)” indicates the feature of the adversarial example x^{s}+δ in which the noise δ is added to the data x^{s}. “∥f(x^{s}+δ)−f(tⁱ)∥₂” indicates an index value by the 12 norm of the similarity between the feature of the adversarial example x^{s}+δ and the feature of the template tⁱ.

“∥f(x^{s}+δ)−f(tⁱ)∥₂≤τ” indicates a determination criterion for the authentication model 910 to determine that the authentication succeeds. Therefore, the minimum perturbation size Δ_{p,imp}¹² indicates the minimum lₚ norm in which the impersonation occurs among the lₚ norm of the noise δ.

If the lₚ norm “∥δ∥ₚ” of the noise δ is smaller than the minimum perturbation size Δ_{p,imp}¹², the authentication model 910 determines that authentication fails with authentication based on the adversarial example x^{s}+δ and the template tⁱ. That is, when the lₚ norm “∥δ∥ₚ” of the noise δ is smaller than the minimum perturbation size Δ_{p,imp}¹², impersonation does not occur.

In general, it is difficult to calculate the minimum perturbation size Δ_{p,imp}¹². Therefore, the robustness evaluation device 300 estimates the lower limit β_{imp,p}¹² of the minimum perturbation size Δ_{p,imp}¹² as the robustness evaluation value. Since β_{imp,p}¹² is the lower limit of the minimum perturbation size Δ_{p,imp}¹², it is expressed by Expression (16).

[Math. 16]

β_{imp,p}¹²≤Δ_{p,imp}¹² (16)

p may be any of 1, 2, and ∞. That is, when the lₚ norm “∥δ∥ₚ” of the noise δ is smaller than the lower limit β_{imp,p}¹² of the minimum perturbation size, impersonation does not occur.

When the feature extractor f, the threshold value τ, the template tⁱ∈R^{d} of the authentication target i, the input data x^{s}∈R^{d} of the authentication target s, and the parameter ε>0 are input, the robustness evaluation device 300 estimates the lower limit β_{imp,p}¹² of the minimum perturbation size and outputs the estimated lower limit as the robustness evaluation value.

The robustness evaluation device 300 calculates the lower limit β_{imp,p}¹² of the minimum perturbation size with respect to the input data x^{s}∈R^{d} of the authentication model 910 using Expression (17).

$$\begin{matrix}[ Math . 17 ] & \\ {β}_{imp , p}^{12} = min \{ \frac{{‖ f ( {x}^{s} ) - f ( {t}^{i} ) ‖}_{2} - τ}{{L}_{{x}^{i} , ε}^{12}} , ε \} & ( 17 )\end{matrix}$$

“τ−∥f(x^{s})−f(tⁱ)∥₂” represents a difference obtained by subtracting the threshold value τ from the similarity between the feature f(x^{s}) calculated from the input data x^{s} and the feature f(tⁱ) calculated from the template tⁱ.

“L_{xs,ε}¹²” indicates a local Lipschitz constant in a sphere Bₚ^{s} of a function h¹²(x) expressed by the above Expression (4).

The sphere Bₚ^{s} is a sphere expressed by Expression (18).

[Math. 18]

Bₚ^{s}={x∈R^{d}|∥x−x^{s}∥ₚ≤ε} (18)

The center of the sphere Bₚ^{s} is x^{s}, and the radius of the sphere Bₚ^{s} is ε.

As a method by which the robustness evaluation device 300 calculates the local Lipschitz constant L_{xs,ε}¹², a known method can be used. For example, the robustness evaluation device 300 may calculate the local Lipschitz constant L_{xs,ε}¹² based on Expression (19).

[Math. 19]

Lₓ_{^{s}}_{,ε}¹²=max{∥∇h¹²(x)∥_{q}:x∈Bₚ^{s}} (19)

Expression (19) is different from Expression (7) in that L_{xs,ε}¹² is on the left side of the Formula and the sphere shown on the right side of the Formula is a sphere Bₚ^{s}. Other than that, Expression (19) is same as Expression (7).

The difference calculation unit 304 calculates a difference “∥f(x^{s})−f(tⁱ)∥₂−τ” obtained by subtracting the threshold value τ from the similarity between the feature f(x^{s}) calculated from the input data x^{s} and the feature f(tⁱ) calculated from the template tⁱ.

The similarity calculation unit 305 of the difference calculation unit 304 calculates the similarity “∥f(x^{s})−f(tⁱ)∥₂” between the feature f(x^{s}) calculated from the input data x^{s} and the feature f(tⁱ) calculated from the template tⁱ.

The local Lipschitz constant estimation unit 306 calculates the local Lipschitz constant L_{xs,ε}¹² described above.

The evaluation value estimation unit 302 calculates “∥f(x^{s})−f(tⁱ)∥₂−τ)/L_{xs,ε}¹²” using the value of “∥f(x^{s})−f(tⁱ)∥₂−τ” calculated by the difference calculation unit 304 and the local Lipschitz constant L_{xs,ε}¹² calculated by the local Lipschitz constant estimation unit 106. The evaluation value estimation unit 302 compares the value of “∥f(x^{s})−f(tⁱ)∥₂−τ)/L_{xs,ε}¹²” with the value of the parameter ε, and outputs the smaller value as the lower limit β_{imp,p}¹² of the minimum perturbation size Δ_{p,imp}¹².

The operation of the robustness evaluation device 300 will be described with reference to FIG. 8.

FIG. 8 is a flowchart illustrating an example of a processing procedure in which the robustness evaluation device 300 calculates the robustness evaluation value of the authentication model.

In the processing of FIG. 8, the evaluation value estimation unit 302 receives inputs of the feature extractor f:R^{d}→R^{m}, the threshold value τ>0, the template tⁱ∈R^{d} of the authentication target i, the input data x^{s}∈R^{d} of the authentication target s, and the parameter ε>0 (step S301).

Next, the difference calculation unit 304 calculates a difference “∥f(x^{s})−f(tⁱ)∥₂−τ” obtained by subtracting the threshold value τ from the similarity between the feature f(x^{s}) calculated from the input data x^{s} and the feature f(tⁱ) calculated from the template tⁱ (step S302). In step S302, the similarity calculation unit 305 calculates the similarity “∥f(x^{s})−f(tⁱ)∥₂” between the feature f(x^{s}) calculated from the input data x^{s} and the feature f(tⁱ) calculated from the template f.

Next, the local Lipschitz constant estimation unit 306 estimates the local Lipschitz constant L_{xs,ε}¹² of the function h¹²(x)=∥f(x)−f(tⁱ)∥₂ in the sphere Bₚ^{s} expressed by the above Expression (18) (step S303).

Next, the evaluation value estimation unit 302 calculates and outputs the lower limit δ_{imp,p}¹² of the minimum perturbation size Δ_{p,imp}¹² (step S104). Specifically, the evaluation value estimation unit 102 calculates “∥f(x^{s})−f(tⁱ)∥₂−τ)/L_{xs,ε}¹²” using the value of “∥f(x^{s})−f(tⁱ)∥₂−τ” calculated by the difference calculation unit 304 and the local Lipschitz constant L_{xs,ε}¹² estimated by the local Lipschitz constant estimation unit 306. The evaluation value estimation unit 302 calculates the smaller value of the value of “∥f(x^{s})−f(tⁱ)∥₂−τ)/L_{xs,ε}¹²” and the value of the parameter ε as the lower limit β_{imp,p}¹² of the minimum perturbation size Δ_{p,imp}¹², and outputs the calculated value.

After step S304, the robustness evaluation device 300 ends the process of FIG. 8.

As described above, the similarity calculation unit 305 calculates the similarity based on the Euclidean distance. The evaluation value estimation unit 302 estimates an evaluation value of the robustness of the authentication model against impersonation, based on a value obtained by subtracting a determination threshold value from the similarity calculated by the similarity calculation unit 305 and subtracting the local Lipschitz constant.

As a result, according to the robustness evaluation device 300, it is possible to quantitatively evaluate the robustness of the authentication model against the adversarial example generated for the purpose of impersonation.

### Fourth Example Embodiment

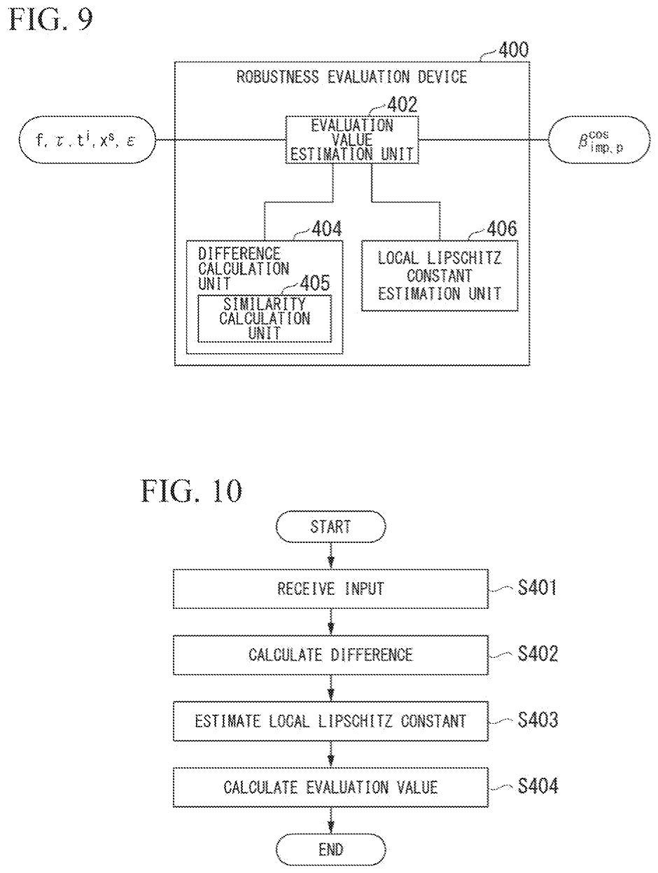

FIG. 9 is a schematic block diagram illustrating a configuration example of a robustness evaluation device according to a fourth example embodiment. In the configuration illustrated in FIG. 9, a robustness evaluation device 400 includes an evaluation value estimation unit 402, a difference calculation unit 404, and a local Lipschitz constant estimation unit 406. The difference calculation unit 404 includes a similarity calculation unit 405.

As in the case of robustness evaluation device 300 (see FIG. 7), the robustness evaluation device 400 calculates a quantitative evaluation value of the robustness of the authentication model against an adversarial example generated for the purpose of “impersonation” in the authentication model.

On the other hand, the robustness evaluation device 400 sets an authentication model using an index indicating that the larger the value, the higher the similarity, as an index of the similarity between the features, as a target for calculating the robustness evaluation value. In this respect, the robustness evaluation device 400 is different from the robustness evaluation device 300.

As described above, when the similarity is calculated using such an index, the authentication model determines the authentication result as an authentication success if an index value of the similarity between the features is equal to or larger than a threshold value, and as an authentication failure if the index value is less than the threshold value. Examples of such an index include cosine similarity.

In the fourth example embodiment, a case where an authentication model using cosine similarity as an index of similarity is a target of calculation of a robustness evaluation value will be described as an example. However, the similarity index used by the authentication model in the fourth example embodiment is not limited to the cosine similarity, and various indices indicating that the larger the value, the higher the similarity may be used.

As in the case of the robustness evaluation device 200, the robustness evaluation device 400 calculates the robustness evaluation value using the authentication model 920 (see FIG. 5).

The robustness evaluation device 400 assumes that the adversarial example x^{s}+δ, obtained by adding the noise δ∈R^{d} to the data x^{s}∈R^{d} of the authentication target s, is input to the authentication model 920, and calculates the robustness evaluation value of the authentication model at that time. The robustness evaluation device 400 estimates the lower limit β_{imp,p}^{cos} of the minimum perturbation size Δ_{p,imp}^{cos} necessary for achieving the impersonation, as the robustness evaluation value.

The minimum perturbation size Δ_{p,imp}^{cos} is expressed by Expression (20).

[Math. 20]

Δ_{p,imp}^{cos}=min∥δ∥ₚs.t. cos(f(x^{s}+δ),f(tⁱ)≥τ (20)

“cos(f(x^{s}+δ)−f(tⁱ)” indicates an index value by the cosine similarity between the feature of the adversarial example x^{s}+δ and the feature of the template tⁱ.

“cos(f(x^{s}+δ),f(tⁱ)≥τ” indicates a determination criterion for the authentication model 910 to determine that the authentication succeeds. Therefore, the minimum perturbation size Δ_{p,imp}^{cos} indicates the minimum lₚ norm in which the impersonation occurs among the lₚ norm of the noise δ.

If the lₚ norm “∥δ∥ₚ” of the noise δ is smaller than the minimum perturbation size Δ_{p,imp}^{cos}, the authentication model 920 determines that authentication fails with an authentication based on the adversarial example x^{s}+δ and the template tⁱ. That is, when the lₚ norm “∥δ∥ₚ” of the noise δ is smaller than the minimum perturbation size Δ_{p,imp}¹², impersonation does not occur.

In general, it is difficult to calculate the minimum perturbation size Δ_{p,imp}^{cos}. Therefore, the robustness evaluation device 400 estimates the lower limit β_{imp,p}^{cos} of the minimum perturbation size Δ_{p,imp}^{cos} as the robustness evaluation value. Since β_{imp,p}^{cos} is the lower limit of the minimum perturbation size Δ_{p,imp}^{cos}, it is expressed by Expression (21).

[Math. 21]

β_{imp,p}^{cos}≤Δ_{p,imp}^{cos} (21)

p may be any of 1, 2, and ∞. That is, when the lₚ norm “∥δ∥ₚ” of the noise δ is smaller than the lower limit β_{imp,p}^{cos} of the minimum perturbation size, impersonation does not occur.

When the feature extractor f, the threshold value τ, the template tⁱ∈R^{d} of the authentication target i, the input data x^{s}∈R^{d} of the authentication target s, and the parameter ε>0 are input, the robustness evaluation device 400 estimates the lower limit β_{imp,p}^{cos} of the minimum perturbation size and outputs the estimated lower limit as the robustness evaluation value.

The robustness evaluation device 400 calculates the lower limit β_{imp,p}^{cos} of the minimum perturbation size with respect to the input data x^{s}∈R^{d} of the authentication model 920 using Expression (22).

$$\begin{matrix}[ Math . 22 ] & \\ {β}_{imp , p}^{cos} = min \{ \frac{τ - cos ( f ( {x}^{s} ) , f ( {t}^{i} ) )}{{L}_{{x}^{s} , ε}^{cos}} , ε \} & ( 22 )\end{matrix}$$

“τ-cos(f(xⁱ),f(tⁱ))” represents a difference obtained by subtracting the similarity between the feature f(xⁱ) calculated from the input data xⁱ and the feature f(tⁱ) calculated from the template tⁱ from the threshold value T.

“L_{xs,ε}^{cos}” indicates the local Lipschitz constant of the function h^{cos}(x) indicated by the above Expression (13) in the sphere Bₚ^{s} indicated by the above Expression (18).

As a method by which the robustness evaluation device 400 calculates the local Lipschitz constant L_{xs,ε}^{cos}, a known method can be used. For example, the robustness evaluation device 400 may calculate the local Lipschitz constant L_{xi,ε}^{cos} based on Expression (23).

[Math. 23]

Lₓ_{^{s}}_{,ε}^{cos}=max{∥∇h^{cos}(x)∥_{q}:x∈Bₚ^{s}} (23)

Expression (23) is different from Expression (14) in that L_{xs,ε}^{cos} is on the left side of the Formula and the sphere shown on the right side of the Formula is a sphere Bₚ^{s}. Other than that, Expression (23) is same as Expression (14).

The difference calculation unit 404 calculates a difference “τ-cos(f(xⁱ),f(tⁱ))” obtained by subtracting the similarity between the feature f(x^{s}) calculated from the input data x^{s} and the feature f(tⁱ) calculated from the template tⁱ from the threshold value τ.

The similarity calculation unit 305 of the difference calculation unit 304 calculates the similarity “cos(f(xⁱ),f(tⁱ))” between the feature f(x^{s}) calculated from the input data x^{s} and the feature f(tⁱ) calculated from the template tⁱ.

The local Lipschitz constant estimation unit 406 calculates the local Lipschitz constant L_{xs,ε}^{cos} described above.

The evaluation value estimation unit 402 calculates “(τ−cos(f(xⁱ),f(tⁱ)))/L_{xs,ε}^{cos}” using the value of “τ−cos(f(xⁱ),f(tⁱ))” calculated by the difference calculation unit 404 and the local Lipschitz constant L_{xs,ε}^{cos} calculated by the local Lipschitz constant estimation unit 206. The evaluation value estimation unit 202 compares the value of “(τ−cos(f(xⁱ),f(tⁱ)))/L_{xs,ε}^{cos}” with the value of the parameter ε, and outputs the smaller value as the lower limit β_{imp,p}^{cos} of the minimum perturbation size Δ_{p,imp}^{cos}.

The operation of the robustness evaluation device 400 will be described with reference to FIG. 10.

FIG. 10 is a flowchart illustrating an example of a processing procedure in which the robustness evaluation device 400 calculates the robustness evaluation value of the authentication model.

In the processing of FIG. 10, the evaluation value estimation unit 402 receives inputs of the feature extractor f:R^{d}→R^{m}, the threshold value τ>0, the template tⁱ ∈R^{d} of the authentication target i, the input data x^{s}∈R^{d} of the authentication target s, and the parameter ε>0 (step S401).

Next, the difference calculation unit 404 calculates a difference “τ−cos(f(x^{s}),f(tⁱ))” obtained by subtracting the similarity between the feature f(x^{s}) calculated from the input data x^{s} and the feature f(tⁱ) calculated from the template tⁱ from the threshold value τ (step S402). In step S402, the similarity calculation unit 405 calculates the similarity “cos(f(x^{s}),f(tⁱ))” between the feature f(x^{s}) calculated from the input data x^{s} and the feature f(tⁱ) calculated from the template tⁱ.

Next, the local Lipschitz constant estimation unit 406 estimates the local Lipschitz constant L_{xs,ε}^{cos} of the function h^{cos}(x)=cos(f(x),f(tⁱ)) in the sphere Bₚ^{s} expressed by the above Expression (18) (step S403).

Next, the evaluation value estimation unit 402 calculates and outputs the lower limit β_{imp,p}^{cos} of the minimum perturbation size Δ_{p,imp}^{cos} (step S404). Specifically, the evaluation value estimation unit 402 calculates “(τ−cos(f(x^{s}),f(tⁱ)))/L_{xs,ε}^{cos}” using the value of “τ−cos(f(x^{s}),f(tⁱ))” calculated by the difference calculation unit 404 and the local Lipschitz constant L_{xs,ε}^{cos} estimated by the local Lipschitz constant estimation unit 406. The evaluation value estimation unit 402 calculates the smaller value of the value of “τ−cos(f(x^{s}),f(tⁱ)))/L_{xs,ε}^{cos}” and the value of the parameter ε as the lower limit β_{imp,p}^{cos} of the minimum perturbation size Δ_{p,imp}^{cos}, and outputs the calculated value.

After step S404, the robustness evaluation device 400 ends the process of FIG. 10.

As described above, the similarity calculation unit 405 calculates cosine similarity. The evaluation value estimation unit 402 estimates an evaluation value of the robustness of the authentication model against impersonation, based on a value obtained by subtracting the similarity calculated by the similarity calculation unit 405 from a determination threshold value.

As a result, according to the robustness evaluation device 400, it is possible to quantitatively evaluate the robustness of the authentication model against the adversarial example generated for the purpose of impersonation.

### Fifth Example Embodiment

In a fifth example embodiment, estimation of a local Lipschitz constant will be described. The fifth example embodiment is applicable to any one of the first to fourth example embodiments.

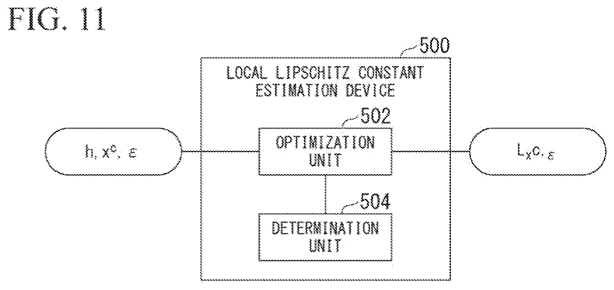

FIG. 11 is a schematic block diagram illustrating a configuration example of a local Lipschitz constant estimation device according to the fifth example embodiment. In the configuration illustrated in FIG. 11, a local Lipschitz constant estimation device 500 includes an optimization unit 502 and a determination unit 504.

As an example of a method for estimating a local Lipschitz constant, there is a method described in Non-Patent Document 1.

Here, a sphere Bₚ is defined as a sphere expressed by Expression (24).

[Math. 24]

Bₚ={x∈R^{d}|∥x−x^{c}∥ₚ≤ε} (18)

Further, q is an integer satisfying the above Expression (9).

It is known that a local Lipschitz constant L_{xc,ε} of the function h:R^{d}→R in the sphere Bₚ is expressed by Expression (25).

$$\begin{matrix}[ Math . 25 ] & \\ {L}_{{x}^{c} , ε} = {max}_{x ∈ {B}_{p}} {‖ ∇ h ( x ) ‖}_{q} & ( 25 )\end{matrix}$$

Non-Patent Document 1 discloses that a plurality of points are sampled from a sphere Bₚ, and a local Lipschitz constant L_{xc,ε} is estimated by a method depending on the sampling.

On the other hand, the local Lipschitz constant estimation device 500 estimates the local Lipschitz constant L_{xc,ε} by a method utilizing the gradient method. It is expected that a more accurate local Lipschitz constant L_{xc,ε} can be estimated by using the gradient method without depending on sampling.

The local Lipschitz constant estimation device 500 receives the function h:R^{d}→R, the center x^{c}∈R^{d}, and the radius ε>0 as inputs, and estimates and outputs the local Lipschitz constant of the function h:R^{d}→R in the sphere Bₚ expressed by Expression (24). The local Lipschitz constant estimation device 500 corresponds to a case where p is 2 and a case where p is ∞.

The local Lipschitz constant estimation device 500 can be used as a local Lipschitz constant estimation unit in any of the robustness evaluation devices 100, 200, 300, and 400. For example, in the case of the robustness evaluation device 100, the function h received as an input by the local Lipschitz constant estimation device 500 is h(x)=∥f(x)−f(tⁱ)∥₂, and the center x^{c}∈R^{d} of the sphere Bₚ is xⁱ∈R^{d}.

The optimization unit 502 estimates the local Lipschitz constant by solving the optimization problem expressed by Expression (26).

[Math. 26]

max∥∇h(x)∥_{q}s.t.x∈Bₚ (26)

The optimization unit 502 determines an initial point x⁰∈R^{d}, and updates the point xⁿ M times based on Expression (27), thereby solving the optimization problem of the above Expression (26).

[Math. 27]

xⁿ=xⁿ⁻¹+1∇∥∇h(xⁿ⁻¹)∥_{q} (27)

xⁿ indicates a point updated n times. xⁿ corresponds to an example of a point at which a candidate for the local Lipschitz constant value is calculated. ∇h(xⁿ⁻¹) indicates the gradient of the function h at the point xⁿ⁻¹.

l represents a learning rate. The local Lipschitz constant estimation device 500 may receive the learning rate l as an input. Alternatively, the learning rate l may be set in the local Lipschitz constant estimation device 500 in advance.

A method for determining the initial point x⁰∈R^{d} is not limited to a specific method.

The local Lipschitz constant estimation device 500 may receive the number of updates M as an input. Alternatively, the number of updates M may be set in the local Lipschitz constant estimation device 500 in advance.

It is expected that the solution of the optimization problem is approached by performing the above update. On the other hand, there is a case where the constraint of the optimization problem is not satisfied during the update. Specifically, there is a case where xⁿ∈Bₚ is not satisfied.

Therefore, the determination unit 504 determines whether xⁿ∈Bₚ is satisfied. When the determination unit 504 determines that xⁿ∈Bₚ is not satisfied, the optimization unit 502 performs correction as follows according to p, so that xⁿ∈Bₚ is satisfied.

In a case of p=2, the optimization unit 502 corrects the point xⁿ as in Expression (28).

$$\begin{matrix}[ Math . 28 ] & \\ {x}^{n} = {x}^{c} + ε \frac{{x}^{n} - {x}^{c}}{{‖ {x}^{n} - {x}^{c} ‖}_{2}} & ( 28 )\end{matrix}$$

In a case of p=∞, the optimization unit 502 corrects the point xⁿ as in Expression (29).

[Math. 29]

xⁿ=[m]=min(xⁿ[m],x^{c}[m]+ε) (29)

m in Expression (29) takes an integer value from 1 to d. xⁿ[m] represents the value of the m-th element of xⁿ.

Both corrections of Expression (28) and Expression (29) are corrections for satisfying xⁿ∈Bₚ.

When updating xⁿ M times by the above method, the optimization unit 502 calculates ∥∇h(xⁿ)∥_{q} for each updated xⁿ. ∥∇h(xⁿ)∥_{q} calculated in each of the updated xⁿ corresponds to an example of a candidate value of the local Lipschitz constant.

Then, the optimization unit 502 outputs the maximum value expressed by Expression (30) among the M calculated values, as the estimated value of the local Lipschitz constant L_{xc,ε}.

$$\begin{matrix}[ Math . 30 ] & \\ {max}_{n = 1 , … , d} {‖ ∇ h ( {x}^{n} ) ‖}_{q} & ( 30 )\end{matrix}$$

The determination unit 504 receives xⁿ updated by the optimization unit 502, determines whether xⁿ∈Bₚ is satisfied, and outputs a determination result to the optimization unit 502.

The determination unit 504 determines whether xⁿ∈Bₚ is satisfied using a formula corresponding to the value of p. In the case of p=2, the determination unit 504 determines whether xⁿ∈Bₚ is satisfied using Expression (31).

[Math. 31]

∥xⁿ−x^{c}∥₂≤ε (31)

In a case where Expression (31) is satisfied, the determination unit 504 determines that xⁿ satisfies xⁿ∈Bₚ. On the other hand, in a case where Expression (31) is not satisfied, the determination unit 504 determines that xⁿ does not satisfy xⁿ∈Bₚ.

In the case of p=∞, the determination unit 504 determines whether xⁿ∈Bₚ is satisfied using Expression (32).

[Math. 32]

∥xⁿ−x^{c}∥_{∞}≤ε (32)

In a case where Expression (32) is satisfied, the determination unit 504 determines that xⁿ satisfies xⁿ∈Bₚ. On the other hand, in a case where Expression (32) is not satisfied, the determination unit 504 determines that xⁿ does not satisfy xⁿ∈Bₚ.

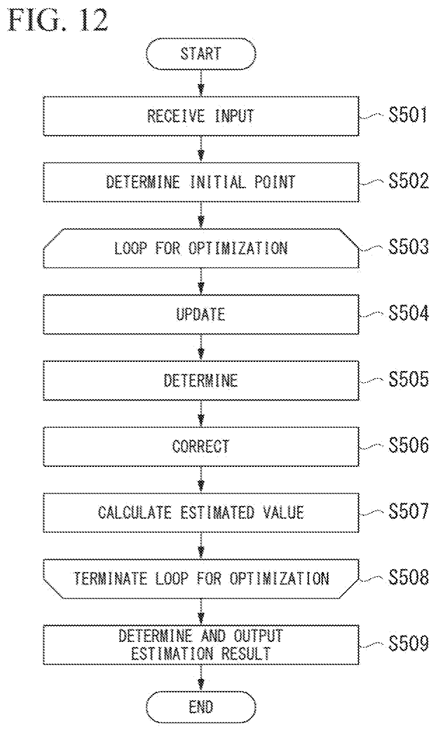

The operation of the local Lipschitz constant estimation device 500 will be described with reference to FIG. 12.

FIG. 12 is a flowchart illustrating an example of a processing procedure in which the local Lipschitz constant estimation device 500 estimates a local Lipschitz constant.

In the processing of FIG. 12, the optimization unit 502 receives the function h:R^{d}→R, the center x^{c}∈R^{d}, and the radius ε>0 as inputs (step S501).

Next, the optimization unit 502 determines the initial point x⁰∈R^{d} (step S502).

Next, the optimization unit 502 starts a loop for performing optimization calculation (step S503).

Next, the optimization unit 502 calculates xⁿ using Expression (27) and outputs xⁿ to the determination unit 504 (step S504). The process of step S504 corresponds to a process of updating xⁿ.

Next, the determination unit 504 determines whether xⁿ satisfies the constraint, and returns the determination result to the optimization unit 502 (step S505).

Next, the optimization unit 502 makes a correction to xⁿ using the correction formula based on the determination result obtained by the determination unit 504 (Step S506). Specifically, in a case where the determination unit 504 determines that xⁿ does not satisfy xⁿ∈Bₚ, the optimization unit 502 corrects the value of xⁿ using either Expression (28) or Expression (29) according to p.

Next, the optimization unit 502 calculates ∥∇h(xⁿ)∥_{q} and stores the obtained value (step S507).

Next, the optimization unit 502 performs termination processing of a loop for optimization calculation (step S508). Specifically, the optimization unit 502 determines whether or not M times of updating have been performed. In a case where it is determined that M times of updating have not been performed, the optimization unit 502 continues to repeat the processing of the optimization loop. In a case where it is determined that M times of updating have been performed, the optimization unit 502 ends the optimization loop.

In a case where the optimization loop is ended, the optimization unit 502 determines one of n=1, . . . , and M in which the value of ∥∇h(xⁿ)∥_{q} is maximized, and outputs the obtained maximum value of ∥∇h(xⁿ)∥_{q} as an estimated value of the local Lipschitz constant L_{xc,ε} (step S509).

After step S509, the local Lipschitz constant estimation device 500 completes the processing of FIG. 12.

As described above, the local Lipschitz constant estimation device 500 repeats the processing of updating the point included in the sphere according to the slope at the point of the function for calculating the similarity, and estimates the maximum value among the candidates of the local Lipschitz constant value calculated for each updated point as the local Lipschitz constant value.

As a result, the local Lipschitz constant estimation device 500 can estimate the local Lipschitz constant. By updating the point at which the candidate for the local Lipschitz constant value is calculated according to the slope of the function for calculating the similarity, for example, it is expected that the local Lipschitz constant can be estimated more accurately than in a case where the candidate for the local Lipschitz constant value is randomly sampled.

### Sixth Example Embodiment

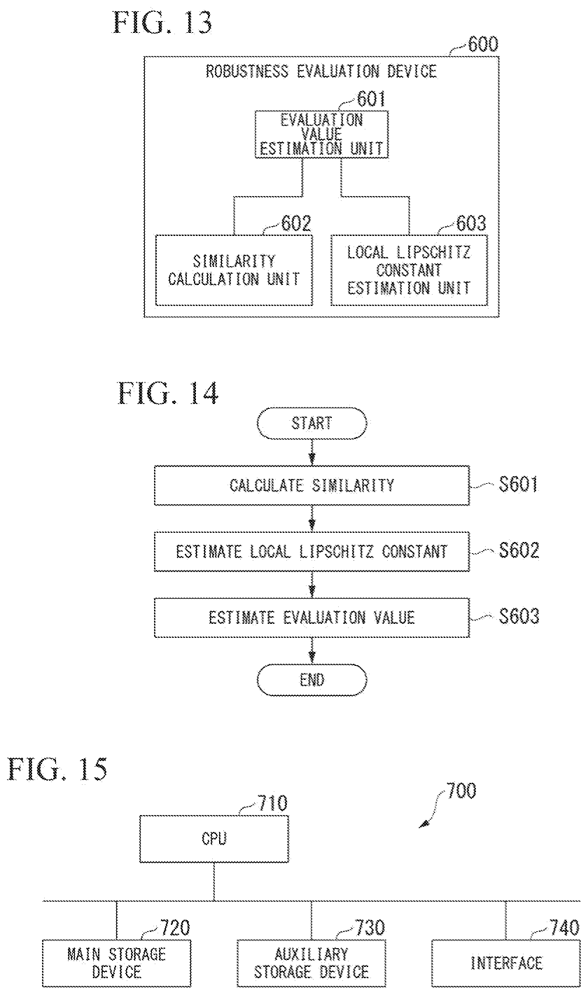

FIG. 13 is a diagram illustrating a configuration example of a robustness evaluation device according to a sixth example embodiment. In the configuration illustrated in FIG. 13, a robustness evaluation device 600 includes an evaluation value estimation unit 601, a similarity calculation unit 602, and a local Lipschitz constant estimation unit 603.

With such a configuration, the similarity calculation unit 602 calculates the similarity between the feature of the input to the authentication model and the feature of the template. The local Lipschitz constant estimation unit 603 estimates a local Lipschitz constant of a function for calculating the similarity between the feature of the input to the authentication model and the feature of the template in the sphere centered on the input to the authentication model. The evaluation value estimation unit 601 estimates the evaluation value of the robustness of the authentication model based on the similarity calculated by the similarity calculation unit 602, the determination threshold value for the similarity, and the local Lipschitz constant.

According to the robustness evaluation device 600, the robustness of the authentication model can be quantitatively evaluated.

### Seventh Example Embodiment

FIG. 14 is a flowchart illustrating an example of a procedure of processing in a robustness evaluation method according to a seventh example embodiment.

The robustness evaluation method illustrated in FIG. 14 includes a similarity calculation step (step S601), a local Lipschitz constant estimation step (step S602), and an evaluation value estimation step (step S603).

In the similarity calculation step (step S601), the similarity between the feature of the input to the authentication model and the feature of the template is calculated. In the local Lipschitz constant estimation step (step S602), a local Lipschitz constant of a function for calculating the similarity between the feature of the input to the authentication model and the feature of the template in the sphere centered on the input to the authentication model is estimated. In the evaluation value estimation step (step S603), the evaluation value of the robustness of the authentication model is estimated based on the similarity calculated in step S601, the determination threshold value for the similarity, and the local Lipschitz constant.

According to the robustness evaluation method illustrated in FIG. 14, the robustness of the authentication model can be quantitatively evaluated.

FIG. 15 is a schematic block diagram illustrating a configuration of a computer according to at least one example embodiment.

In the configuration illustrated in FIG. 15, a computer 700 includes a central processing unit (CPU) 710, a main storage device 720, an auxiliary storage device 730, and an interface 740.

Any one or more of the robustness evaluation devices 100, 200, 300, 400, and 600 and the local Lipschitz constant estimation device 500 described above may be implemented in the computer 700. In that case, the operation of each processing unit described above is stored in the auxiliary storage device 730 in the form of a program. The CPU 710 reads the program from the auxiliary storage device 730, deploys the program in the main storage device 720, and executes the above processing according to the program. In addition, the CPU 710 secures a storage area corresponding to each of the above-described storage units in the main storage device 720 according to the program.

When the robustness evaluation device 100 is implemented in the computer 700, the operations of the evaluation value estimation unit 102, the difference calculation unit 104, the similarity calculation unit 105, and the local Lipschitz constant estimation unit 106 are stored in the auxiliary storage device 730 in the form of a program. The CPU 710 reads the program from the auxiliary storage device 730, deploys the program in the main storage device 720, and executes the operation of each unit according to the program.

The output of the evaluation value of the robustness of the authentication model is executed by the interface 740 having an output function such as a communication function or a display function and performing output processing under the control of the CPU 710.

When the robustness evaluation device 200 is implemented in the computer 700, the operations of the evaluation value estimation unit 202, the difference calculation unit 204, the similarity calculation unit 205, and the local Lipschitz constant estimation unit 206 are stored in the auxiliary storage device 730 in the form of a program. The CPU 710 reads the program from the auxiliary storage device 730, deploys the program in the main storage device 720, and executes the operation of each unit according to the program.

The output of the evaluation value of the robustness of the authentication model is executed by the interface 740 having an output function such as a communication function or a display function and performing output processing under the control of the CPU 710.

When the robustness evaluation device 300 is implemented in the computer 700, the operations of the evaluation value estimation unit 302, the difference calculation unit 304, the similarity calculation unit 305, and the local Lipschitz constant estimation unit 306 are stored in the auxiliary storage device 730 in the form of a program. The CPU 710 reads the program from the auxiliary storage device 730, deploys the program in the main storage device 720, and executes the operation of each unit according to the program.

The output of the evaluation value of the robustness of the authentication model is executed by the interface 740 having an output function such as a communication function or a display function and performing output processing under the control of the CPU 710.

When the robustness evaluation device 400 is implemented in the computer 700, the operations of the evaluation value estimation unit 402, the difference calculation unit 404, the similarity calculation unit 405, and the local Lipschitz constant estimation unit 406 are stored in the auxiliary storage device 730 in the form of a program. The CPU 710 reads the program from the auxiliary storage device 730, deploys the program in the main storage device 720, and executes the operation of each unit according to the program.

The output of the evaluation value of the robustness of the authentication model is executed by the interface 740 having an output function such as a communication function or a display function and performing output processing under the control of the CPU 710.

When the local Lipschitz constant estimation device 500 is implemented in the computer 700, the operations of the optimization unit 502 and the determination unit 504 are stored in the auxiliary storage device 730 in the form of a program. The CPU 710 reads the program from the auxiliary storage device 730, deploys the program in the main storage device 720, and executes the operation of each unit according to the program.

The output of the estimated value of local Lipschitz constant is executed by the interface 740 having an output function such as a communication function and performing output processing under the control of the CPU 710.

When the robustness evaluation device 600 is implemented in the computer 700, the operations of the evaluation value estimation unit 601, the similarity calculation unit 602, the local Lipschitz constant estimation unit 603 are stored in the auxiliary storage device 730 in the form of a program. The CPU 710 reads the program from the auxiliary storage device 730, deploys the program in the main storage device 720, and executes the operation of each unit according to the program.

The output of the evaluation value of the robustness of the authentication model is executed by the interface 740 having an output function such as a communication function or a display function and performing output processing under the control of the CPU 710.

Note that a program for realizing all or part of the functions of the robustness evaluation devices 100, 200, 300, 400, and 600 and the local Lipschitz constant estimation device 500 may be recorded in a computer-readable recording medium, and the program recorded in the recording medium may be read and executed by a computer system to perform processing of each unit. The “computer system” herein includes an operating system (OS) and hardware such as peripheral devices.

The “computer-readable recording medium” refers to a portable medium such as a flexible disk, a magneto-optical disk, a read only memory (ROM), or a compact disc read only memory (CD-ROM), or a storage device such as a hard disk built in a computer system. In addition, the program may be for realizing a part of the functions described above, and the functions described above may be realized in combination with a program already recorded in the computer system.

Although the example embodiment of the present invention has been described in detail with reference to the drawings, the specific configuration is not limited to this example embodiment, and includes design changes and the like without departing from the gist of the present invention.

### INDUSTRIAL APPLICABILITY

The example embodiments of the present invention may be applied to a robustness evaluation device, a robustness evaluation method, and a recording medium.

### REFERENCE SIGNS LIST

100, 200, 300, 400, 600 Robustness evaluation device
102, 202, 302, 402, 601 Evaluation value estimation unit
104, 204, 304, 404 Difference calculation unit
105, 205, 305, 405, 602 Similarity calculation unit
106, 206, 306, 406, 603 Local Lipschitz constant estimation unit
500 Local Lipschitz constant estimation device
502 Optimization unit
504 Determination unit

1. A robustness evaluation device comprising:
at least one memory configured to store instructions; and
at least one processor configured to execute the instructions to:
calculate a similarity between a feature of an input to an authentication model and a feature of a template;
repeat processing of updating a point included in a sphere centered on the input to an authentication model, according to a slope at the point of a function for which a local Lipschitz constant value is to be estimated;
estimate a maximum value among candidates of the local Lipschitz constant value calculated for each updated point as the local Lipschitz constant value for the function; and
estimate an evaluation value of robustness of the authentication model based on the similarity, a determination threshold value for the similarity, and the local Lipschitz constant.

2. The robustness evaluation device according to claim 1, wherein the at least one processor is configured to execute the instructions to:
calculate the similarity based on a Euclidean distance; and
estimate the evaluation value of the robustness of the authentication model against authentication dodging based on a value obtained by subtracting the similarity from the determination threshold value and dividing by the local Lipschitz constant.

3. The robustness evaluation device according to claim 1, wherein the at least one processor is configured to execute the instructions to:
calculate cosine similarity, and
estimate the evaluation value of the robustness of the authentication model against authentication dodging based on a value obtained by subtracting the determination threshold value from the similarity and dividing by the local Lipschitz constant.

4. The robustness evaluation device according to claim 1, wherein the at least one processor is configured to execute the instructions to:
calculate the similarity based on a Euclidean distance; and
estimate the evaluation value of the robustness of the authentication model against impersonation based on a value obtained by subtracting the determination threshold value from the similarity and dividing by the local Lipschitz constant.

5. The robustness evaluation device according to claim 1, wherein the at least one processor is configured to execute the instructions to:
calculate cosine similarity, and
estimate the evaluation value of the robustness of the authentication model against impersonation based on a value obtained by subtracting the similarity from the determination threshold value and dividing by the local Lipschitz constant.

6. A robustness evaluation method comprising:
calculating a similarity between a feature of an input to an authentication model and a feature of a template;
repeating processing of updating a point included in a sphere centered on the input to an authentication model, according to a slope at the point of a function for which a local Lipschitz constant value is to be estimated;
estimating a maximum value among candidates of the local Lipschitz constant value calculated for each updated point as the local Lipschitz constant value for the function; and
estimating an evaluation value of robustness of the authentication model based on the similarity, a determination threshold value for the similarity, and the local Lipschitz constant.

7. The robustness evaluation method according to claim 6, wherein
calculating the similarity comprises calculating the similarity based on a Euclidean distance, and
estimating the evaluation value estimating the evaluation value of the robustness of the authentication model against authentication dodging based on a value obtained by subtracting the similarity from the determination threshold value and dividing by the local Lipschitz constant.

8. The robustness evaluation method according to claim 6, further comprising:
calculating cosine similarity,
wherein estimating the evaluation value comprises estimating the evaluation value of the robustness of the authentication model against authentication dodging based on a value obtained by subtracting the determination threshold value from the similarity and dividing by the local Lipschitz constant.

9. The robustness evaluation method according to claim 6, wherein
calculating the similarity comprises calculating the similarity based on a Euclidean distance, and
estimating the evaluation value comprises estimating the evaluation value of the robustness of the authentication model against impersonation based on a value obtained by subtracting the determination threshold value from the similarity and dividing by the local Lipschitz constant.

10. The robustness evaluation method according to claim 6, further comprising:
calculating cosine similarity,
wherein estimating the evaluation value comprises estimating the evaluation value of the robustness of the authentication model against impersonation based on a value obtained by subtracting the similarity from the determination threshold value and dividing by the local Lipschitz constant.

11. A non-transitory recording medium in which a program is recorded, the program causing a computer to execute:
calculating a similarity between a feature of an input to an authentication model and a feature of a template;
repeating processing of updating a point included in a sphere centered on the input to an authentication model, according to a slope at the point of a function for which a local Lipschitz constant value is to be estimated;
estimating a maximum value among candidates of the local Lipschitz constant value calculated for each updated point as the local Lipschitz constant value for the function; and
estimating an evaluation value of robustness of the authentication model based on the similarity, a determination threshold value for the similarity, and the local Lipschitz constant.

12. The non-transitory recording medium in which a program is recorded according to claim 11, wherein
calculating the similarity comprises calculating the similarity based on a Euclidean distance, and
estimating the evaluation value estimating the evaluation value of the robustness of the authentication model against authentication dodging based on a value obtained by subtracting the similarity from the determination threshold value and dividing by the local Lipschitz constant.

13. The non-transitory recording medium in which a program is recorded according to claim 11, wherein the program further causes the computer to execute:
calculating cosine similarity,
wherein estimating the evaluation value comprises estimating the evaluation value of the robustness of the authentication model against authentication dodging based on a value obtained by subtracting the determination threshold value from the similarity and dividing by the local Lipschitz constant.

14. The non-transitory recording medium in which a program is recorded according to claim 11, wherein
calculating the similarity comprises calculating the similarity based on a Euclidean distance, and
estimating the evaluation value comprises estimating the evaluation value of the robustness of the authentication model against impersonation based on a value obtained by subtracting the determination threshold value from the similarity and dividing by the local Lipschitz constant.

15. The non-transitory recording medium in which a program is recorded according to claim 11, wherein the program further causes the computer to execute:
calculating cosine similarity,
wherein estimating the evaluation value comprises estimating the evaluation value of the robustness of the authentication model against impersonation based on a value obtained by subtracting the similarity from the determination threshold value and dividing by the local Lipschitz constant.
